(19) United States
(12) Patent Application Publication
(10) Pub. No.: US 2011/0295847 A1
(43) Pub. Date: Dec. 1, 2011

(54) CONCEPT INTERFACE FOR SEARCH ENGINES

(75) Inventors: Silviu-Petru Cucerzan, Redmond, WA (US); Christopher J. C. Burges, Bellevue, WA (US)

(73) Assignee: MICROSOFT CORPORATION, Redmond, WA (US)

(21) Appl. No.: 12/791,347

(22) Filed: Jun. 1, 2010

(51) Int. Cl. G06F 17/30

(52) U.S. Cl. 707/723; 707/765; 707/E17.014; 707/E17.062

(57) ABSTRACT

Concepts are presented related to a search engine query. Users can subsequently navigate search results and/or reformulate a query at a conceptual level. In one instance, users can specify weight with respect to one or more concepts to capture interest or lack of interest with respect to search intent. Based on one or more weights, a search query can be modified and results presented to a user along with associated concepts to enable continued interaction. Additionally or alternatively, organization and/or presentation of search results as well as advertisements can be influenced by user-specified weights or other interactions with concepts.

### BACKGROUND

Search engines are utilized to maximize the likelihood of locating relevant information amongst an abundance of data. For instance, search engines are often employed over the World Wide Web (a.k.a. Web) or a subset thereof to facilitate locating and accessing websites of interest as a function of a search query comprising one or more keywords and operators. Upon receipt of a query, the search engine retrieves a list of websites that match the query, generates a snippet of text associated with each website, and displays the links to the websites and the corresponding text, typically ranked based on relevance. Furthermore, advertisements relating to the search terms can also be presented together with the results. The user can thereafter scroll through a plurality of returned websites and ads in an attempt to identify information of interest. However, this can be an extremely time-consuming and frustrating process for the user, as search engines can return a substantial amount of content. Further, users often have to narrow a search iteratively by altering and/or adding keywords and operators to a query in an attempt to locate content that better matches search intent.

To assist users in the process of narrowing their search, most search engines include a query suggestion feature. More specifically, one or more queries are suggested based on a user-specified query, among other things. In some implementations, such query suggestions are generated and provided dynamically in a search box as a query is entered. Additionally or alternatively, query suggestions are provided statically, for instance, alongside of search results.

There are a number of techniques for deriving query suggestions, typically from historical search data (e.g., most popular queries). Current query suggestion paradigms present a limited number (usually fewer than 10) of query formulations to users and force users decide which one, if any, best matches their search intent. Selecting one of the query suggestions results in presentation of search results corresponding to the selected query formulation, as if the user manually typed that query into a search box.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally concerns facilitating location of relevant search results utilizing concepts and more particularly a concept-based interface. Concepts related to a search query can be suggested to a user by way of presentation, for instance in combination with search results, among other things. Subsequently, users can interact with the concepts in various ways to assist in navigating to results that satisfy their query intent. In accordance with one embodiment, a user can specify a weight with respect to one or more of the suggested concepts to identify the user's desire to see more or less of a concept in search results. Subsequently, a search query can be modified and/or search results can be reorganized as a function of weight. Additionally or alternatively, organization and/or presentation of search results as well as advertisements can be influenced by user-specified weights or other interactions with concepts.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a search system that facilitates conceptual query refinement and interaction.

FIG. 2 is a block diagram of a representative concept-interface component.

FIG. 3 depicts an exemplary presentation embodiment of a concept interface component.

FIGS. 4 & 5 are representative screenshots illustrating exemplary use of a concept interface.

FIG. 6 is a flow chart diagram of a method of query refinement in a conceptual space.

FIG. 7 is a flow chart diagram of a method of conceptual interaction with search results.

FIG. 8 is a flow chart diagram a method of advertising with respect to concept based searching.

FIG. 9 is a flow chart diagram of method of concept extraction.

FIG. 10 is a schematic block diagram illustrating a suitable operating environment for aspects of the subject disclosure.

### DETAILED DESCRIPTION

Details below are generally directed toward facilitating location of relevant search results utilizing concepts. Rather than merely suggesting popular queries, concepts related to a query can be suggested. Further, users can interact with the concepts, including combing concepts, to refine a query at a conceptual level thereby providing more flexibility than selecting a single suggested query.

In accordance with an embodiment, concepts related to a search query can be presented by way of a concept interface, wherein concepts are extracted from a search query, and query results, among other resources. A user-specified weight can subsequently be received for at least one of the concepts and actions can be initiated based on the weight. For instance, a search query can be modified as a function of the weight and a new search executed. Additionally or alternatively, organization and/or presentation of search results and advertisements can also be influenced by the user-specified weight or other interaction with concepts.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

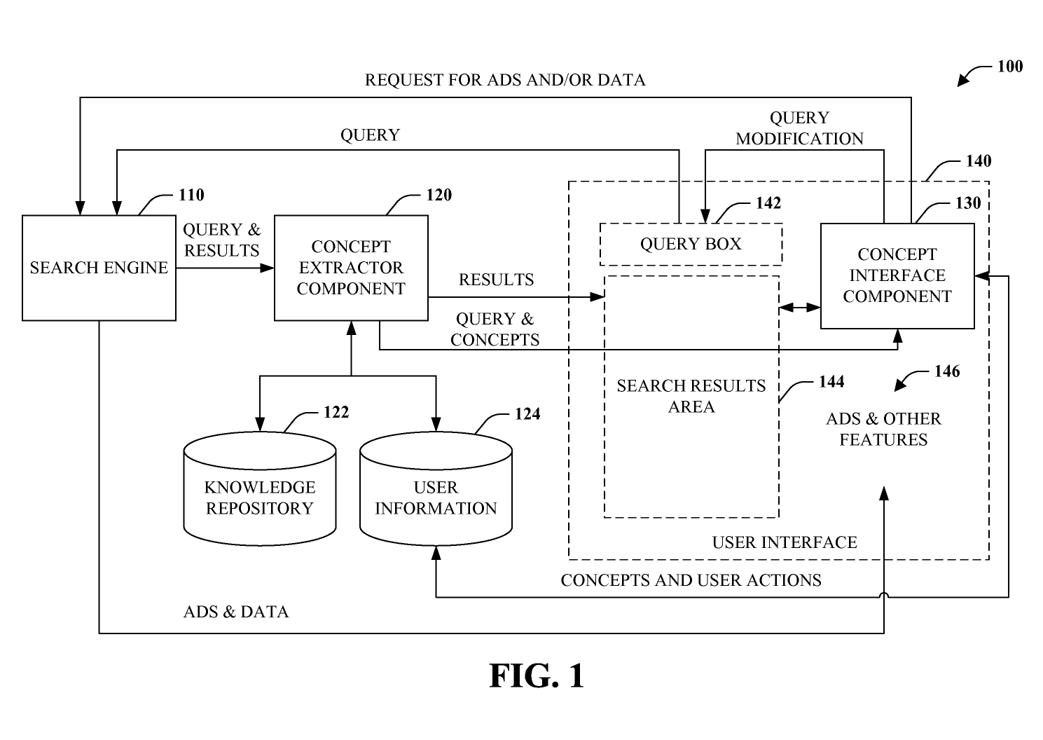

Referring initially to FIG. 1, a search system 100 is illustrated that facilitates conceptual query refinement and interaction. The search system 100 includes a search engine 110, a concept extractor component 120, and a concept interface component 130. The search engine 110 can correspond to any search engine known in the art that aids in retrieval of documents, files, and/or data. For example, a search engine can correspond to known Web search engines (e.g., Bing®, Google®, Yahoo® . . . ), among other types. In accordance with one embodiment, the search engine 110 can be utilized as is or in other words without any modification thereto. However, at least a portion of functionality described hereinafter can be incorporated into the search engine 110.

As shown, the search engine 110 can receive queries from users by way of user interface 140 and more specifically as specified with respect to search query box 142 of the user interface 140. In response, the search engine 110 can generate and output search results matching an input query. Further, the search engine 110 can also provide one or more advertisements (ads) relevant to the query and optionally data for other various search related functionality.

The concept extractor component 120 acquires output from the search engine 110 including the search query and results and determines or otherwise infers concepts related to the search. Concepts are abstract or general ideas that can be derived or inferred from specific instances or occurrence. For instance, concepts can be nouns or noun phrases, either common (e.g., spreadsheet) or proper (e.g., Microsoft Office®). In one embodiment, one or more classifiers can be employed to indentify concepts from search result snippets (e.g., one or more short excerpts or an abstract of the text from the documents retrieved for a query). Further, each snippet can be deemed a coherent piece of text and as such local context can be utilized to disambiguate text. For example, if a snippet includes “White House” and “Bush,” it can be hypothesized that “Bush” refers to the president rather than the NASCAR driver or a shrub.

Various resources can be employed by the concept extractor component 120 to aid in identifying concepts and related concepts including a knowledge repository 122 and user information 124. Although not limited thereto, in one embodiment the knowledge repository can be an online encyclopedia or like data repository. The concept extractor component 120 can utilize knowledge help identify and disambiguate concepts in search results as well as identify related concepts. User information 124 can include previous interactions as well as more personal information (e.g., documents, e-mail, dwell time . . . ), subject to consent, which can be utilized to identify and/or constrain extracted concepts so as to tailor concepts to particular users.

Upon identification of concepts related to a search query by the concept extractor component 120, the query, search results, and concepts can be provided to the user interface 140 for presentation. More specifically, query results can be rendered in a search results area 144 and the query and concepts can be provided to the concept interface component 130.

The concept interface component 130 enables a user to interact with concepts and modify search results, among other things. Upon receipt of a query and concepts from the concept extractor component 120, the concept interface component 130 displays, or otherwise presents, the concepts along with functionality to specify interest with respect to the concepts. For example, various graphical user interface components can be utilized to identify a weight associated with a concept where the weight identifies a users desire to see more or less of a concept in search results. Based on weights received with respect to presented concepts, the original query can be modified by the concept interface component 130 or associated functionality. A new search can subsequently be initiated by way of the user interface 140 or concept interface component 130 with respect to the modified query.

In addition or as an alternative to query modification, the concept interface component 130 can provide other features to facilitate navigation of search results. In one embodiment, results in the search results area 144 can be reorganized as a function of specified concept weights. For example, search results can be re-ranked taking into account the weights. In another embodiment, the concept interface component 130 can at least initiate the presentation of visually distinct concepts in the search results. By way of example and not limitation, favorably weighted concepts can be colored or highlighted green while negatively weighted concepts can be colored or highlighted red. In this manner, users can easily identify concepts within the search results. Further yet, the concept interface component 130 can initiate retrieval of advertisements and/or data for other user interface features 146, as a function of user interaction with concepts separate from initiating a new search. Consequently, advertisements, for instance, can be dynamically adjusted as a function of weights assigned to concepts.

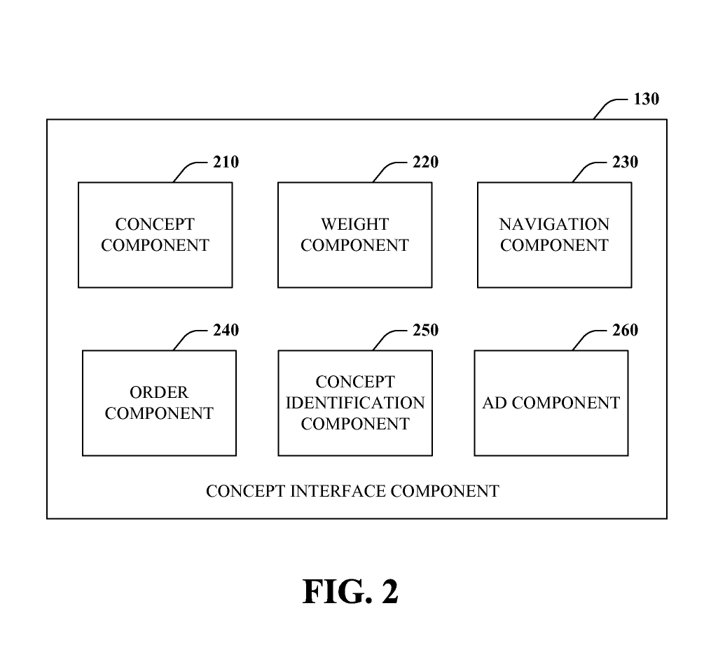

FIG. 2 is a block diagram illustrating components/sub-components of a representative concept-interface component 130. As shown, the concept interface component 130 can include a concept component 210, a weight component 220, and a navigation component 230. The concept component 210 receives, retrieves or otherwise acquires or obtains a query and concepts relating thereto and presents the concepts to a user.

The weight component 220 provides a means to allow users to specify, and the concept interface component 130 to receive, weights or other judgments relevant to query intent. Weights can be binary (e.g., relevant/irrelevant) or fuzzy (e.g. relevant/irrelevant to a certain degree). Accordingly, a text box, slider, or button, among other things, can be provided to accept concept weights.

The navigation component 230 provides a means to allow back and forth navigation amongst search sessions (e.g., submitted query and returned results) in order to allow changes in concept selection and retrieval of new search results. After a query is modified, for example based on provided concept weights, new search results and concepts are returned. A user can continue to refine a search by specifying weights with respect to the new concepts and initiating another search iteratively until the user is satisfied with the results. However, in some instance the user may desire to go back and adjust some weights previously entered based on the results returned, for instance. In the process of adjusting the weights, the user may want to move backward and forward to find one set of suggested concepts for which to adjust the concepts weights and initiate a new search. The navigation component 230 provides this functionality, for example by saving previous concepts and weights and allowing access thereto in a manner that facilitates in-session as well as cross-search session changes.

The concept interface component 130 also includes an order component 240, which provides a means for at least initiating ordering or reorganization of search query results as a function of specified weights. In one embodiment, such functionality can be performed dynamically. For example, as weights are changed search results are re-ranked consistent with the changes in weights. Of course, ordering can also be explicitly initiated after one or more changes in concept weights are made and/or a search is initiated.

Also provided by the concept interface component 130 is concept identification component 250. Alone or in combination with re-ordering, concepts can be identified distinctly in search results. For example, various character colors, highlighting, and/or fonts, among other things can be utilized to distinguish concepts from other words or content provided in the search results. In one instance, concept identification can be confined to concepts with positive and/or negative weights. For instance, favorably weighted concepts can be rendered in a first color while unfavorably weighted concepts can be presented in a second color. Further, the color shade, tint, and/or brightness, among other things, can also be adjusted to reflect fuzzy weight values. However, weights need not be adjusted for concept identification. For example, a user can hover over or otherwise select (e.g., click, highlight . . . ) a concept for identification by the concept identification component 250.

The concept interface component 130 additionally includes advertisement component 260 to enable retrieval of advertisements separate from search initiation. In other words, a query can be issued for advertisements as a function of weights specified with respect to concepts, for instance. This proactive approach to advertisement presentation allows a user to view relevant advertisements before search results, which means there is a higher probability of the user selecting an advertisement because the advertisements are the most relevant content presented. As an alternative to, or in combination with, issuing a query for additional/different advertisements, the advertisement component 260 can apply a filter to previously provided advertisements, for instance, to re-rank advertisements and potentially display advertisements that were previously pruned due to a lack of space or relevancy, among other factors.

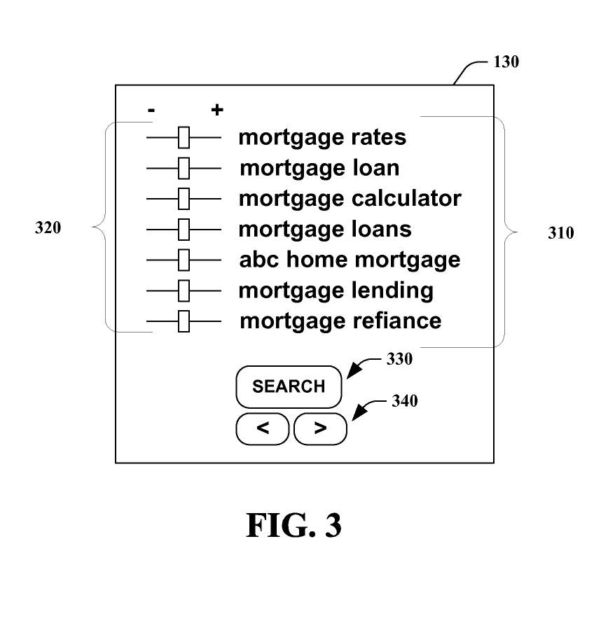

Turning attention to FIG. 3, an exemplary presentation embodiment of a concept interface component 130 is provided. As shown, the concept interface component 130 includes a plurality of concepts on the right side and numerous sliders 320 corresponding to the plurality of concepts on the left side. Preferences regarding concepts can be input by moving the slider toward the plus sign if more results including a concept are desired or toward the minus sign if this concept is to be minimized or excluded. When the slider is in the middle, the default, no preference is specified either for or against a concept. Advantageously, various combinations of weights and concepts can be specified to allow a user to focus a query rather than simply selecting a single suggested query. After weights are specified, the search button 330 can be selected to initiate a modified search. Further, navigation buttons 340 are provided to enable navigation backward or forward with respect to weights and concepts. For example, a user can employ navigation buttons 340 to explore different sets of concepts until concepts are located for which weight modification is desired.

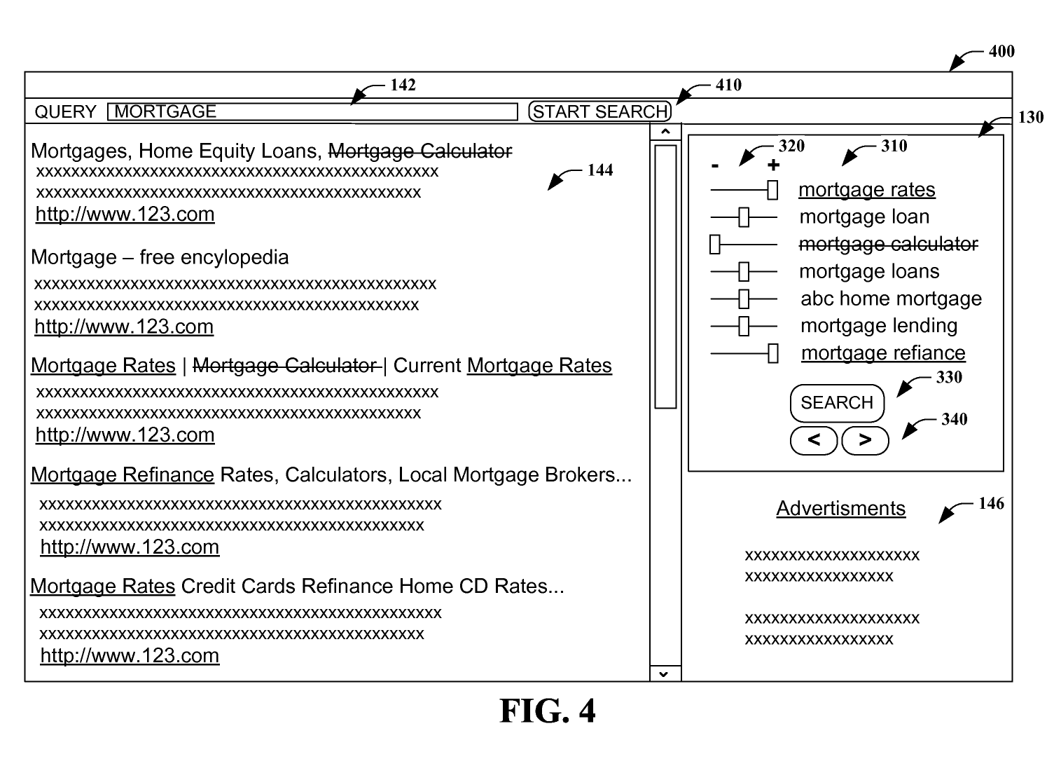

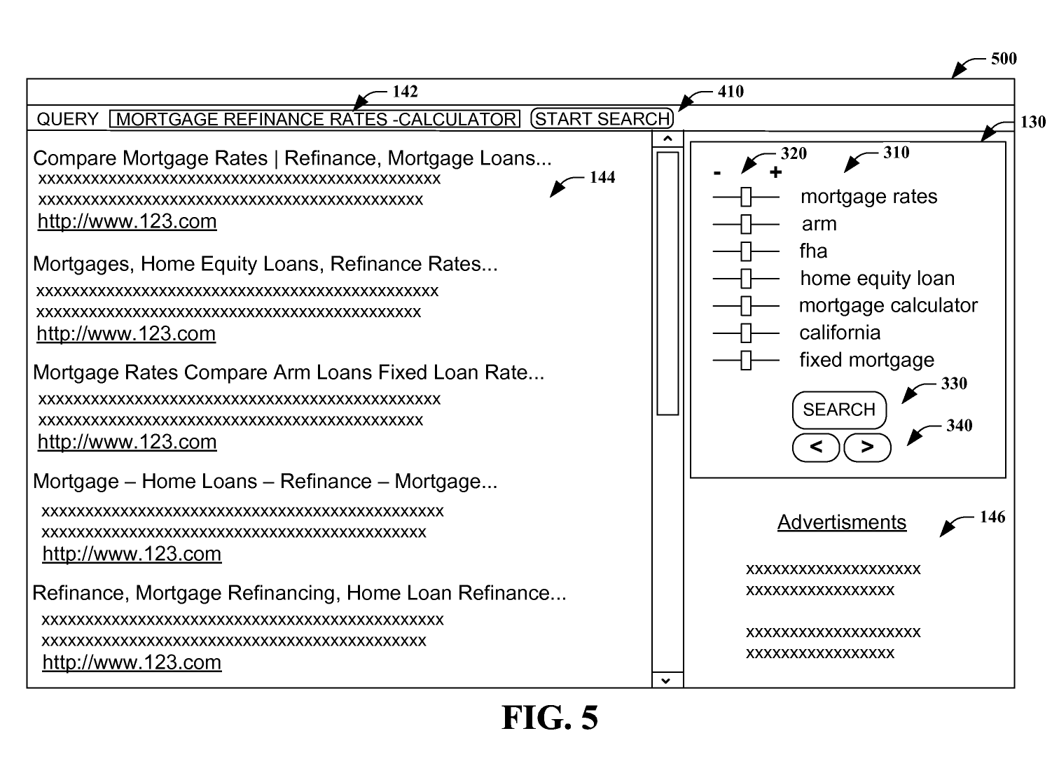

FIGS. 4 and 5 provide screenshots 400 and 500 associated with an example use of the concept interface component 130. As depicted in screenshot 400 of FIG. 4, a query for “MORTGAGE” was entered into the search query box 142 and a search initiated by selecting “START SEARCH” button 410. Results of the query for “MORTGAGE” are provided in search results area 144. Further, advertisements relevant to the query are displayed at 146. Further yet, relevant concepts 310 are presented within the concept interface component 130. As illustrated, weights have been specified with respect to “mortgage rates,” “mortgage calculator,” and “mortgage refinance,” yet a new search has not yet been initiated. Additionally, weighted concepts are visually distinguished from other text in the search result area 144 and the concept interface component 130. More specifically, positively weighted concepts “mortgage rates” and “mortgage refinance” are underlined while the negatively weighted concept “mortgage calculator” is shown with a strike through line. Although not apparent from the screenshot 400, it is to be appreciated that a query for advertisements alone may be issued to provide advertisements relevant to the concept weights. Upon selection of “SEARCH” button 330, screenshot 500 of FIG. 5 results.

As shown in screenshot 500, a new query was issued in search query box 142 respecting, for example, specified binary concept weights, namely “mortgage refinance rates—calculator.” Consequently, search results, concepts, and advertisements can are also updated at 144, 310, and 146 respectively. Further, the weights for updated concepts have been set to a default position at 320 (e.g., zero). The weights can be adjusted to narrow the search further. Alternatively, navigation buttons 340 can be employed to navigate back to the previously presented concepts in screenshot 400, for example to adjust weights in view of the results provided in screenshot 500 and then navigate forward to the concepts provided in screenshot 400.

As will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the concept extractor component 120 can employ such mechanism to infer concepts from a search and other reference sources.

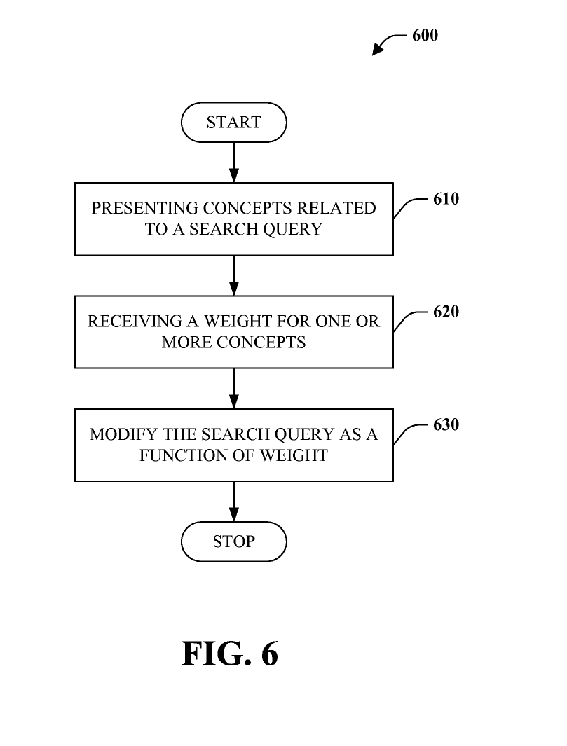

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a method of query refinement in a conceptual space 600 is illustrated. At reference numeral 610, concepts related to a search query are presented. The concepts are abstract or general ideas that can be derived or inferred from the search query, query results, and optionally other reference sources (e.g., knowledge repository, user information . . . ). At numeral 620, a weight can be received for one or more of the presented concepts, wherein the weight identifies a user's preference for concepts with respect to query intent. In one instance, the weight can be binary indicating that a user has a preference for or against a concept. Alternatively, weights can be fuzzy, or in other words, the weights can specify a degree or magnitude of preference perhaps as a vector. At numeral 630, a search query is modified as a function of received concept weights. For example, search terms and/or operators can be added to reflect user preference.

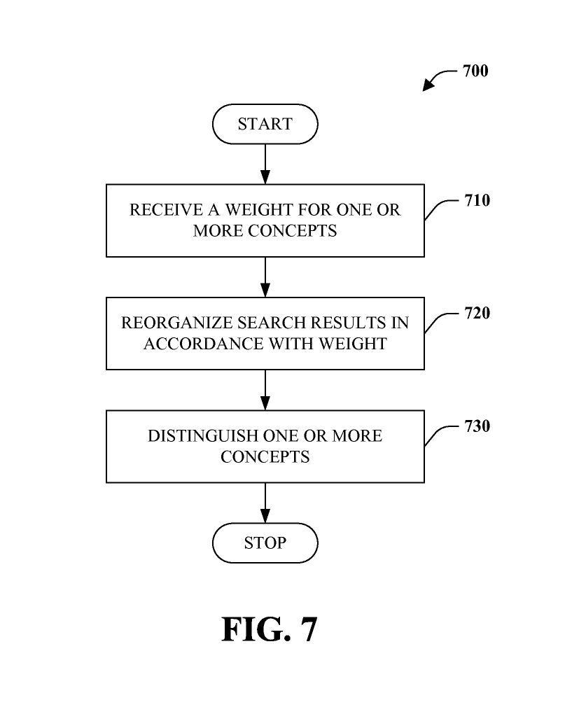

FIG. 7 depicts a method 700 that facilitates conceptual interaction with search results. At reference numeral 710, a weight is received with respect to one or more concepts. At 720, search results are reorganized in accordance with the weight. For instance, search results can be re-ranked dynamically upon receipt of concept weights. At numeral 730, concepts can be distinguished from other words or content in search results. By way of example, selected or weighted concepts can be visually distinguished by way of coloring, highlighting, font, size, and/or type, among other things. For instance, positively weighted concepts can be colored green while negatively weighted concepts can be colored red.

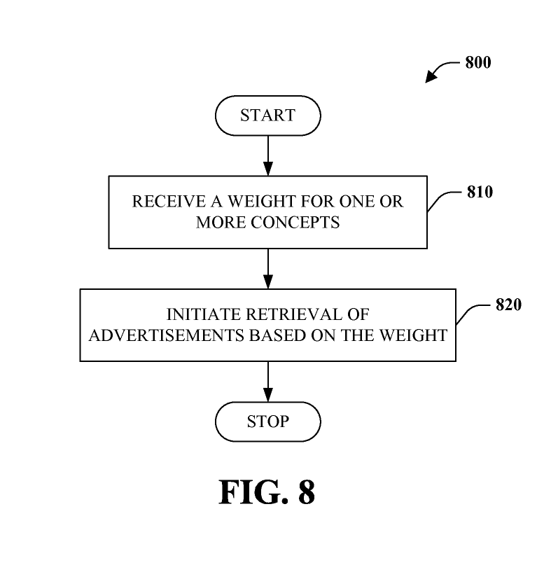

FIG. 8 is a flow chart diagram of a method 800 of advertising with respect to concept-based searching. At reference numeral 810, weight associated with one or more concepts is received, for example from a user by way of a concept interface. At numeral 820, retrieval of advertisements based on concept weights can be initiated. For example, a query for can be submitted to a search engine for advertisements. Although not limited thereto, in this manner, advertisements can be retrieved dynamically either as concept weights are adjusted or periodically. Highly relevant advertisements can be retrieved and presented to users. In one embodiment, the advertisements can be the most relevant content on a user interface display thereby resulting in a potentially higher advertisement selection (e.g., click through), among other things.

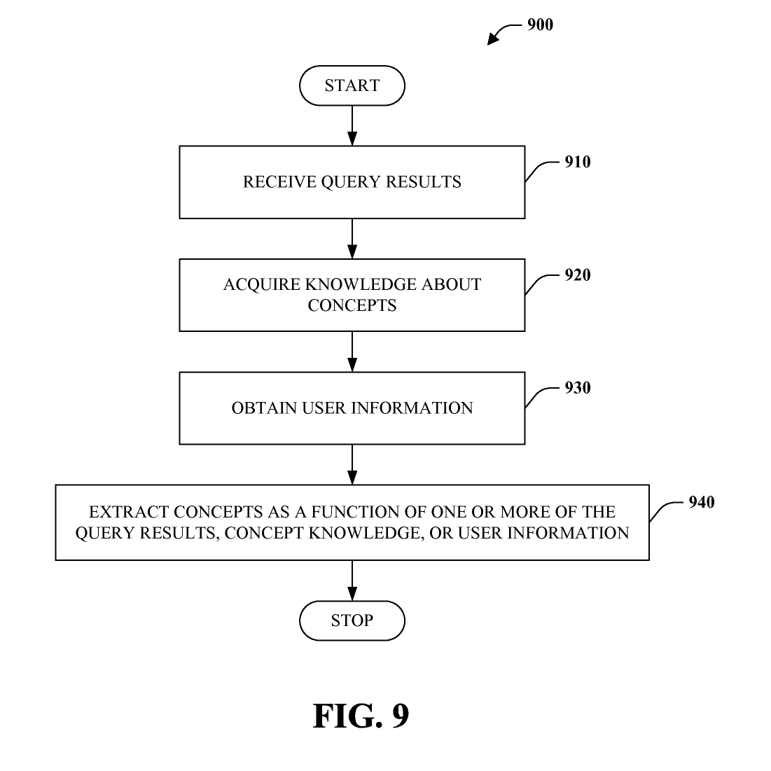

FIG. 9 illustrates a concept extraction method 900. At numeral 910, a query and search results are received, retrieved, or otherwise obtained, for example, from a search engine. At reference 920, knowledge regarding concepts is received or retrieved, for instance, from a knowledge repository such as but not limited to an online encyclopedia or other like data repository. At numeral 930, user information can be received or retrieved. Such information can include historical interaction information. Other user information can include preferences, e-mails, and dwell time, among other things. Of course, the types of user information available can be governed by a privacy policy, user consent, or the like. At reference numeral 940, concepts are extracted as a function of the query, search results, knowledge regarding concepts, and/or user information. By way of example, the knowledge repository can be utilized to facilitate disambiguating concepts from non-concepts in search results as well as identifying related concepts. User information can further aid in this process by personalizing selected concepts.

As used herein, the terms “component,” “system,” and “engine” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

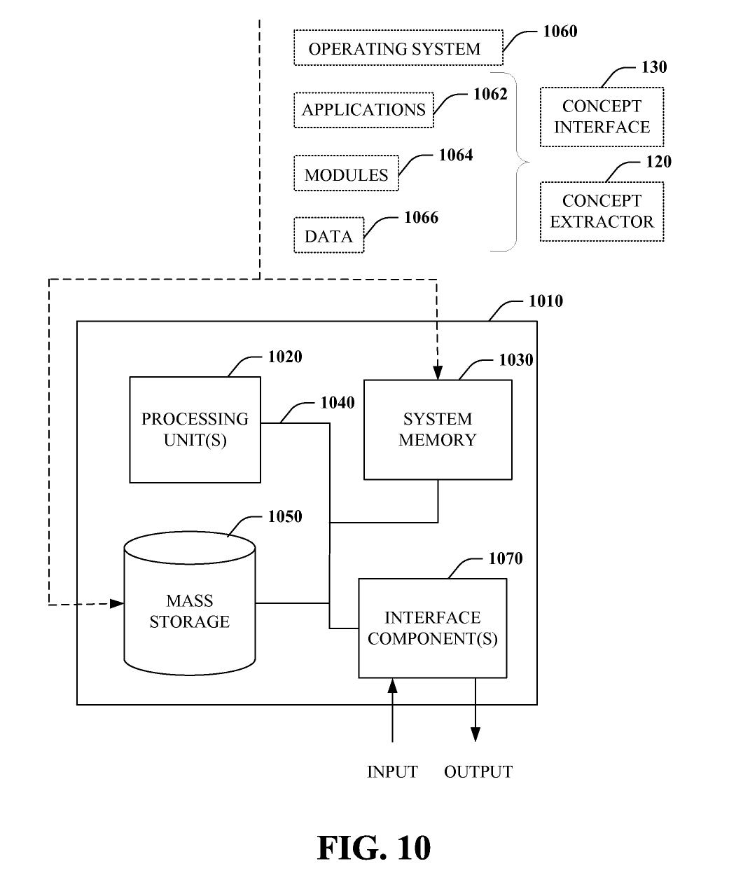

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example computer or computing device 1010 (e.g., desktop, laptop, server, hand-held, programmable consumer or industrial electronics, set-top box, game system . . . ). The computer 1010 includes one or more processing units or processors 1020, system memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to system memory 1030 that execute various computer executable actions, instructions, and or components.

The processing unit 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processing unit 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1030 and mass storage 1050 are examples of computer-readable storage media. Depending on the exact configuration and type of computing device, system memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processing unit 1020, among other things.

Mass storage 1050 includes removable/non-removable, volatile/non-volatile computer storage media for storage of large amounts of data relative to the system memory 1030. For example, mass storage 1050 includes, but is not limited to, one or more devices such as a magnetic or optical disk drive, floppy disk drive, flash memory, solid-state drive, or memory stick.

System memory 1030 and mass storage 1050 can include or have stored therein operating system 1060, one or more applications 1062, one or more program modules 1064, and data 1066. The operating system 1060 acts to control and allocate resources of the computer 1010. Applications 1062 include one or both of system and application software and can leverage management of resources by operating system 1060 through program modules 1064 and data 1066 stored in system memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the search system 100 including concept interface component 130 and concept extractor component 120 can be an application 1062 or part of an application 1062 and include one or more modules 1064 and data 1066 stored in memory and/or mass storage 1050 whose functionality can be realized when executed by one or more processors or processing units 1020, as shown.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating identification of relevant search results, comprising:
employing at least one processor configured to execute computer-executable instructions stored in memory to perform the following acts:
presenting concepts related to a search query;
receiving a weight for at least one of the concepts; and
initiating an action with respect to the search query or search results as a function of the weight.

2. The method of claim 1, further comprising modifying the search query as a function of the weight.

3. The method of claim 1, further comprising visually distinguishing concept instances in a search result set as a function of the weight.

4. The method of claim 1, further comprising changing presentation of search results as a function of the weight.

5. The method of claim 1, further comprising initiating retrieval of advertisements as function of concept weight.

6. The method of claim 1, further comprising extracting the concepts from the search results for the search query and optionally employing a knowledge repository to aid identification of the concepts.

7. The method of claim 1, further comprising presenting concepts related to the search query obtained based on concept navigation input.

8. A graphical user-interface, comprising:
a processor coupled to a memory, the processor configured to execute the following computer-executable components stored in the memory:
a first interface component configured to present concepts related to a search query; and
a second interface component configured to receive a weight for at least one of the concepts.

9. The graphical user interface of claim 8, further comprising a third interface component configured to modify the search query as a function of the weight.

10. The graphical user interface of claim 9, further comprising a forth interface component configured to initiate a search with the search query as modified.

11. The graphical user interface of claim 8, further comprising a third interface component configured to receive input regarding navigation to or from at least one previously presented concept.

12. The graphical user interface of claim 8, further comprising a third interface component configured to at least initiate visually distinguishing concept instances in a result set as a function of the weight.

13. The graphical user interface of claim 8, further comprising a third component configured to at least initiate retrieval of advertisements as a function of the weight.

14. The graphical user interface of claim 8, further comprising a third component configured to at least initiate reorganization of search results as a function of the weight.

15. A system of facilitating location of relevant information with a search engine, comprising:
a processor coupled to a memory, the processor configured to execute the following computer-executable component stored in the memory:
a first component configured to reformulate a search query as a function of one or more weights specified by a user with respect to one or more concepts related to the search query.

16. The system of claim 15, further comprising a second component configured to organize search results based on the one or more weights.

17. The system of claim 15, further comprising a second component configured to initiate retrieval of one or more advertisements as a function of the one or more weights.

18. The system of claim 15, further comprising a second component configured to extract concepts from query search results.

19. The system of claim 18, the second component is configured to extract concepts utilizing a knowledge repository.

20. The system of claim 19, the second component is configured to extract concepts as a function of at least one of interaction history or user specific information.
